(19) United States
(12) Patent Application Publication
(10) Pub. No.: US 2007/0146533 A1
(43) Pub. Date: Jun. 28, 2007

(54) CMOS Image Sensor and Method for Manufacturing the Same

(76) Inventor: Young Je Yun, Ansan-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/611,166

(22) Filed: Dec. 15, 2006

(30) Foreign Application Priority Data
Dec. 28, 2005 (KR) 10-2005-0132607

(51) Int. Cl. H04N 5/225

(52) U.S. Cl. 348/340

(57) ABSTRACT

Provided is a complementary metal oxide semiconductor (CMOS) image sensor and method of manufacturing the same. The image sensor can include a plurality of photodiodes, an interlayer insulating layer, a color filter layer formed of a plurality of color filters, and a plurality of microlenses. The plurality of photodiodes can be formed in a semiconductor substrate, and the interlayer insulating layer can be formed on the semiconductor substrate including the photodiodes. The plurality of color filters can be formed on the interlayer insulating layer such that each color filter corresponds to at least two of the plurality of photodiodes. The plurality of microlenses can be formed on the color filter layer.

### RELATED APPLICATION(S)

This application claims the benefit under 35 U.S.C. §119(e), of Korean Patent Application Number 10-2005-0132607 filed Dec. 28, 2005, which is incorporated herein by reference in its entirety.

### FIELD OF THE INVENTION

The present invention relates to an image sensor with an improved light receiving capability.

### BACKGROUND OF THE INVENTION

In general, an image sensor is a semiconductor device that converts an optical image into an electrical signal. An image sensor is typically classified as a charge coupled device (CCD) image sensor or a complementary metal oxide semiconductor (CMOS) image sensor.

A CMOS image sensor includes a photodiode unit for detecting incident light and converting the detected light into an electrical signal, and a CMOS logic circuit for processing the electric signal to provide corresponding data. As the amount of light that is capable of being received in the photodiode increases, the photo sensitivity of the image sensor increases.

In order to increase the photo sensitivity, one method that has been employed is to increase a fill factor of the photodiode area within the total area of the image sensor. Another method that has been employed is to change an optical path of the light incident on the area outside the photodiode so as to condense light to the photodiode.

One typical example of a method employing light condensing is to form a microlens. This method provides a convex microlens formed of a material having excellent light transmittance on a top surface of the photodiode to refract the incident light such that a larger amount of light is illuminated to the photodiode.

Hereinafter, a related art CMOS image sensor will be described with reference to the accompanying drawings.

FIG. 1 is a cross-sectional view of a related art CMOS image sensor, and FIG. 2 is a plan view illustrating a color filter layer of a related art CMOS image sensor.

Referring to FIG. 1, the CMOS image sensor includes a semiconductor substrate 11, a plurality of photodiodes 12, an interlayer insulating layer 13, a color filter layer 14, an overcoat layer 15, and a plurality of microlenses 16.

The plurality of photodiodes 12 are formed in the semiconductor substrate to generate electric charges corresponding to an amount of incident light.

The interlayer insulating layer 13 is formed on an entire surface of the semiconductor substrate 11 including the photodiode 12.

The color filter layer 14 is formed on the interlayer insulating layer 13. The color filter layer 14 includes a plurality of color filters each corresponding to a respective photodiode 12 to transmit light of respective wavelength bands.

The overcoat layer 15 is formed on the color filter layer 14 for planarizing the entire surface of the substrate.

The microlens 16 is formed on the overcoat layer 15. The microlens has a convex shape of a predetermined curvature to condense light to the photodiode 12 through the photodiode's respective corresponding color filters. The microlens 16 is formed by performing a thermal reflow process to a photoresist.

Referring to FIGS. 1 and 2, the color filter layer 14 is formed by exposure and development processes after coating the substrate with a photoresist, and generally includes red, green, and blue color filters. Gaps d, more specifically, first gaps d1 in a horizontal direction and second gaps d2 in a vertical direction are formed between the color filters of the color filter layer 14 during the manufacturing process.

FIG. 2 shows an array of color filters and their corresponding photodiodes 12, a plurality of which form a unit cell.

Because gaps are formed between the color filters, unfiltered light may pass through the gaps and be condensed to the photodiodes 12 therebelow. Therefore, the related art CMOS image sensor has a disadvantage that noise, crosstalk, and the like may occur, thereby degrading a characteristic of the image sensor.

### SUMMARY OF THE INVENTION

Accordingly, the present invention is directed to a CMOS image sensor and a method for manufacturing the same that addresses and/or substantially obviates one or more problems, limitations, and/or disadvantages of the related art.

An object of the present invention is to provide a CMOS image sensor capable of minimizing degradation of the image sensor by reducing a gap between color filters and a method for manufacturing the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a complementary metal oxide semiconductor image sensor, including: a plurality of photodiodes formed in a semiconductor substrate; an interlayer insulating layer formed on the semiconductor substrate including the plurality of photodiodes; a color filter layer formed of a plurality of color filters formed on the interlayer insulating layer such that each one of the plurality of color filters corresponds to at least two photodiodes of the plurality of photodiodes; and a plurality of microlenses formed on the color filter layer.

In another aspect of the present invention, there is provided a unit cell of a complementary metal oxide semiconductor image sensor, the unit cell including: at least a portion of each of a plurality of color filters; and a plurality of photodiodes selected from photodiodes formed below the plurality of color filters.

In yet another aspect of the present invention, there is provided a method for manufacturing a complementary metal oxide semiconductor image sensor, the method including: forming a plurality of photodiodes in a semiconductor substrate; forming an interlayer insulating layer on a substrate including the photodiodes; forming a color filter layer by forming a plurality of color filters on the interlayer insulating layer such that each one of the color filters corresponds to at least two photodiodes of the plurality of photodiodes; and forming a plurality of microlenses on the color filter layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross sectional view of a complementary metal oxide semiconductor (CMOS) image sensor according to the related art;

FIG. 2 is a plan view illustrating a color filter layer of a related art CMOS image sensor;

FIG. 3 is a cross sectional view illustrating a CMOS image sensor according to an embodiment of the present invention;

FIG. 4 is a plan view illustrating a color filter layer of a CMOS image sensor according to an embodiment of the present invention; and

FIGS. 5A to 5D are cross sectional views illustrating a method for manufacturing a CMOS image sensor according to an embodiment of the present invention.

### DETAILED DESCRIPTION OF THE INVENTION

Reference will now be made in detail to the preferred embodiments of the present invention, examples of which are illustrated in the accompanying drawings.

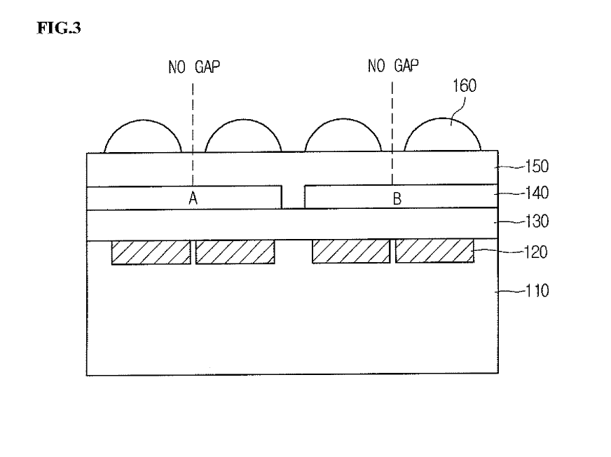

FIG. 3 is a cross sectional view illustrating a complementary metal oxide semiconductor (CMOS) image sensor according to an embodiment of the present invention, and FIG. 4 is a plan view illustrating a color filter layer of a CMOS image sensor according to an embodiment of the present invention.

Referring to FIG. 3, a CMOS image sensor according to an embodiment of the present invention can include a semiconductor substrate 110, a photodiode 120, an interlayer insulating layer 130, a color filter layer 140, an overcoat layer 150, and a microlens 160.

A plurality of photodiodes 120 can be formed in the semiconductor substrate 110 to generate electric charges corresponding to an amount of incident light.

The interlayer insulating layer 130 can be formed on the entire surface of the semiconductor substrate 110 including the plurality of photodiodes 120. The interlayer insulating layer 130 can be used to insulate a wiring layer or the like. The interlayer insulating layer 130 may be formed of either a single layer or multiple layers.

The color filter layer 140, including a plurality of color filters separated from each other, can be formed on the interlayer insulating layer. Each of the color filters can correspond to a plurality of photodiodes 120. Referring to FIG. 4, for example, each of the color filters corresponds to four photodiodes 120. In a specific embodiment, the color filters may include red, green, and blue filters.

Referring to FIGS. 3 and 4, because the color filter layer 140 is formed such that each one of the color filters corresponds to four photodiodes, an area of the color filter is four times greater than the related art color filter Accordingly, there is no gap in some portions of an area where gaps are formed in the related art image sensor. Therefore, the degradation of an image sensor caused by gaps between the color filters can be reduced.

The overcoat layer 150 can be formed on the color filter layer 140. The overcoat layer 150 can be formed over the entire surface of the semiconductor substrate 110 including the color filter layer 140 to improve device reliability. In one embodiment, the overcoat layer 150 can be formed of epoxy molding compounds (EMC) or silicon nitride. The overcoat 150 can be used to prevent moisture or heavy metals from penetrating during a packaging process.

As the microlenses 160 are formed such that each of the microlenses correspond to a respective photodiode 120, a plurality of adjacent microlenses 160 condense light of the same color. Referring to FIG. 3, the color filter layer 140 can be formed such that each one of the color filters corresponds to four photodiodes 120. Therefore, in such an embodiment four adjacent microlenses 160 condense light of the same color.

In an embodiment, a unit cell displaying color can condense light that has passed through a plurality of color filters. That is, according to embodiments of the present invention, at least two photodiodes can correspond to one color filter, and one unit cell can include a plurality of photodiodes 120 corresponding to a plurality of color filters.

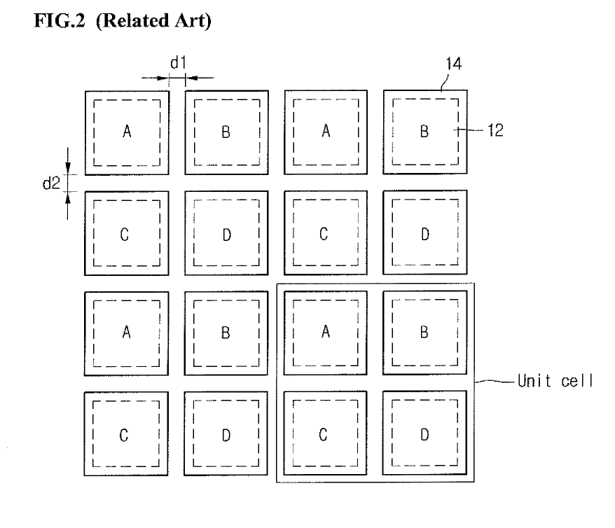

A comparison of FIG. 4 with FIG. 2 shows that an embodiment of the present invention increases the area of each color filter and minimizes gaps between the color filters. In particular, instead of three first gaps d1 in a horizontal direction and three second gaps d2 in a vertical direction as shown in FIG. 2, there is only one first gap d1 in a horizontal direction and only one second gap d2 in a vertical direction as shown in FIG. 4.

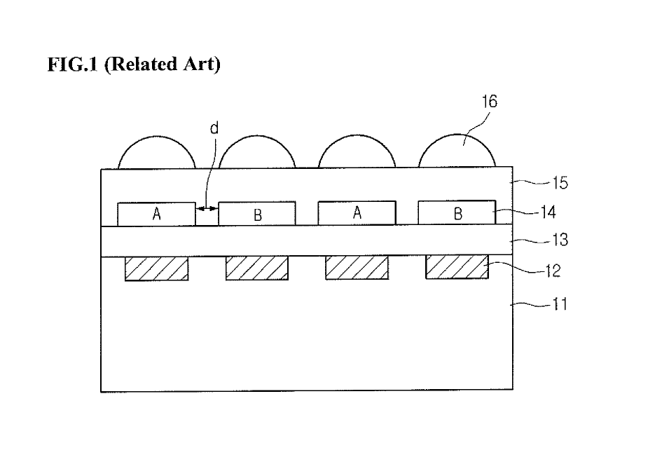

Furthermore, as the gaps between the color filters 140 are minimized, the area of the photodiodes 120 corresponding to one color filter may be maximized. That is, a comparison of FIG. 3 with FIG. 1 shows that a gap between photodiodes 120 corresponding to one color filter is narrower in FIG. 3 than in FIG. 1. This can be credited to the elimination of the gaps between some of the color filters of FIG. 1 by the combination of the color filters to one large color filter as shown in FIG. 3.

As the gap between the photodiodes 120 becomes narrower, the area of the photodiodes 120 can be increased by that amount, which makes it possible to improve the characteristics of an image sensor.

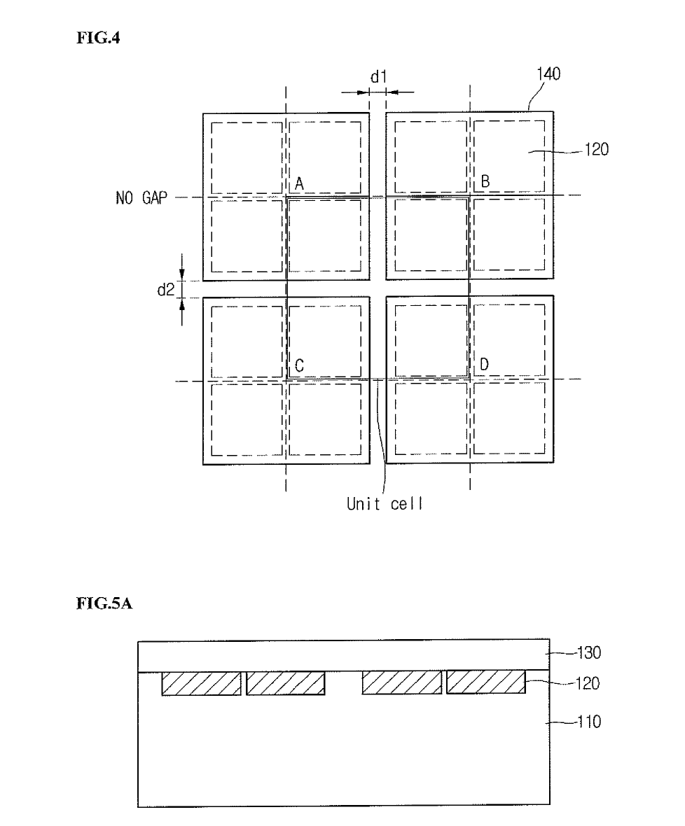

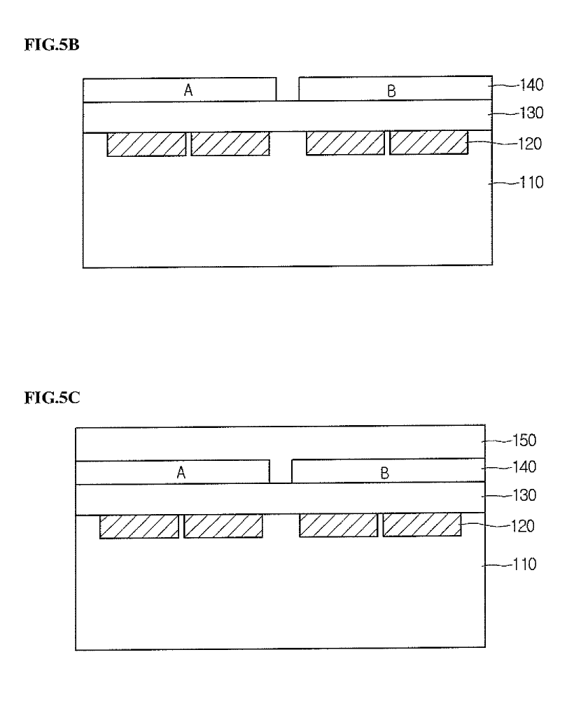

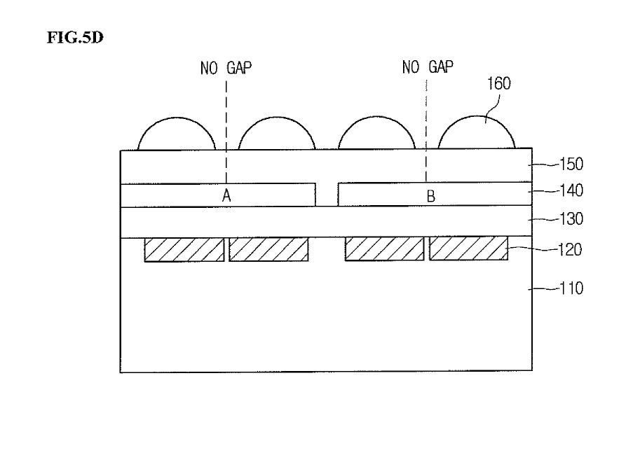

FIGS. 5A to 5D are cross sectional views illustrating a method for manufacturing a CMOS image sensor according to an embodiment of the present invention.

First, an interlayer insulating layer 130 can be formed on an entire surface of a semiconductor substrate 110 in which a plurality of photodiodes 120 are formed. In one embodiment, the interlayer insulating layer 130 can be formed of multiple layers.

Then, as shown in FIG. 5B, a color filter layer 140, including a plurality of color filters, can be formed on the interlayer insulating layer 130 such that each of the plurality of color filters corresponds to a plurality of photodiodes 120. Referring to FIG. 5B, for example, a color filter layer 140 can be formed such that each of the plurality of color filters corresponds to four photodiodes 120.

In one embodiment, the color filter layer 140 can include red (R), green (G), and blue (B) color filters, each filtering light of respective wavelength bands. The color filter layer 140 can be formed by exposure and development processes after coating the substrate with a dyeable resist.

Then, in a further embodiment as shown in FIG. 5C, an overcoat layer 150 can be formed on the color filter layer 140.

In a specific embodiment, the overcoat layer 150 can be formed by depositing a silicon nitride layer on the color filter layer 140.

In a preferred embodiment, since optical transmission is very important in an image sensor, the overcoat layer 150 can be formed to have a thickness of 1000˜6000 Å to prevent interference phenomena of the layers caused by the thickness of the overcoat layer 150.

Referring to FIG. 5D, microlenses 160 can be formed on the overcoat layer 150.

In an embodiment, the microlenses 160 can be formed each corresponding to a photodiode.

In a specific embodiment, the microlenses 160 can be formed to have a convex shape by a process including: coating the substrate with a photoresist; exposing a predetermined region of the photoresist to light; developing the photoresist to form predetermined gaps in the photoresist; and performing a thermal reflow process to the photoresist.

The thermal reflow process can be performed by a heat treatment at 150˜220° C. on a hot plate such that the convex shaped microlenses can be completed by the thermal reflow process.

A process of cooling the microlenses may be further included after the thermal reflow process.

According to embodiments of the present invention described above, each of the color filters corresponds to a plurality of photodiodes in contrast to the related art image sensor where each color filter corresponds to one photodiode. Therefore, gaps between the color filters can be decreased on the whole to reduce noise, cross talk, and the like.

It will be apparent to those skilled in the art that various modifications and variations can be made in the present invention. Thus, it is intended that the present invention covers the modifications and variations of this invention provided they come within the scope of the appended claims and their equivalents.

I claim:

1. A complementary metal oxide semiconductor image sensor, comprising:
a plurality of photodiodes formed in a semiconductor substrate;
an interlayer insulating layer formed on the semiconductor substrate including the plurality of photodiodes;
a color filter layer formed of a plurality of color filters formed on the interlayer insulating layer, wherein each of the plurality of color filters corresponds to at least two photodiodes of the plurality of photodiodes; and
a plurality of microlenses formed on the color filter layer.

2. The image sensor according to claim 1, further comprising an overcoat layer formed between the color filter layer and the plurality of microlenses, the plurality of microlenses being formed on the overcoat layer.

3. The image sensor according to claim 1, wherein at least two microlenses are formed on each of the plurality of color filters.

4. The image sensor according to claim 1, wherein each of the plurality of color filters corresponds to four photodiodes of the plurality of photodiodes.

5. A unit cell of a complementary metal oxide semiconductor image sensor, the unit cell comprising:
at least a portion of each of a plurality of color filters, wherein each of the plurality of color filters corresponds to at least two photodiodes formed below the plurality of color filters; and
a plurality of photodiodes, wherein the plurality of photodiodes are selected from the at least two photodiodes formed below the plurality of color filters.

6. The unit cell according to claim 5, wherein the plurality of photodiodes comprise adjacent photodiodes selected from the at least two photodiodes formed below adjacent color filters of the plurality of color filters.

7. The unit cell according to claim 5, wherein the plurality of color filters are arranged in grid patterns.

8. The unit cell according to claim 5, wherein the at least two photodiodes below each of the plurality of color filters are arranged in grid patterns.

9. The unit cell according to claim 5, wherein the plurality of photodiodes comprise four adjacent photodiodes formed below four adjacent color filters.

10. A method for manufacturing a complementary metal oxide semiconductor image sensor, the method comprising:
forming a plurality of photodiodes in a semiconductor substrate;
forming an interlayer insulating layer on a substrate including the photodiodes;
forming a color filter layer by forming a plurality of color filters on the interlayer insulating layer, wherein each of the color filters corresponds to at least two photodiodes of the plurality of photodiodes; and
forming a plurality of microlenses on the color filter layer.

11. The method according to claim 10, further comprising forming an overcoat layer between the color filter layer and the plurality of microlenses, the plurality of microlenses being formed on the overcoat layer.

12. The method according to claim 10, wherein forming a plurality of microlenses on the color filter layer comprises forming at least two microlenses on each of the plurality of color filters.

13. The method according to claim 10, wherein each of the plurality of color filters correspond to four photodiodes of the plurality of photodiodes.
